(19) United States
(12) Patent Application Publication
(10) Pub. No.: US 2010/0196129 A1
(43) Pub. Date: Aug. 5, 2010

(54) Mobile vacuum excavation process

(76) Inventor: Lynn A. Buckner, Flintstone, GA (US)

Correspondence Address: LYNN A. BUCKNER, P.O. BOX 609, CHICKAMAUGA, GA, 30707, US

(21) Appl. No.: 12/653,871

(22) Filed: Dec. 18, 2009

Related U.S. Application Data
(63) Continuation-in-part of application No. 11/809,957, filed on Jun. 4, 2007.
(60) Provisional application No. 61/277,201, filed on Sep. 22, 2009.
(60) Provisional application No. 61/275,411, filed on Aug. 28, 2009.
(60) Provisional application No. 61/203,830, filed on Dec. 30, 2008.

(51) Int. Cl. B60P 1/60; E01H 1/08

(52) U.S. Cl. 414/467; 15/340.1

(57) ABSTRACT

A compact mobile vacuum boring, and excavation method comprising a device which will create a vacuum condition within a vacuum container and having a vacuum conduit to air convey a liquid and or solid particles into the vacuum container. The vacuum container air inlet & outlet conduit arrangement may also facilitate the separation of solids from the vacuumed air flow by producing a cyclone effect within the vacuum container. A circular cyclone effect is created within the vacuum container by the arrangement relationship between the inlet and outlet vacuum air conduits and baffles. As the air velocity slows, the solids precipitate out of the air and settle in the vacuum container. A housing with filters disposed within it is also adjacently mounted near the vacuum container in order to reduce the quantity of connecting conduits and facilitate a compact, efficient and clean interaction between the vacuum container and the filter housing. The vacuum container access door and the filter housing access door may be adjacently placed in near proximity to each other for user friendly access to empty and clean the vacuum container and filter house or a common door may access both. A compressible seal and conduit arrangement may be used as a quick disconnect between the vacuum producing means and the filter housing. A reversing valve arrangement may be used to back flow air through the filter. Sensors, data gathering, data logging and documentation of a service event may be included. The above systems may be mounted on a variety of mobile platforms.

This patent application is a CIP of Non Provisional application Ser. No. 11/809,957 filed 4 Jun. 2007 whose parent was application Ser. No. 11/208,565 filed Aug. 22, 2005 This application claims the benefit of provisional application No. 61/277,201 filed 22 Sep. 2009 and provisional application No. 61/275,411 filed on 28 Aug. 2009 and provisional application No. 61/203,830 filed on 30 Dec. 2008; and claims the benefits of provisional application No. 60/810,747 filed Jun. 5, 2006, and claims the benefits of provisional application No. 60/814,791 filed Jun. 20, 2006, and claims the benefits of provisional application No. 60/814,721 filed Jun. 20, 2006.

### BACKGROUND OF THE INVENTION

1. Field of the Invention

The present invention relates to a compact mobile vacuum boring and excavation method having a power supply, generally being a combustion engine, a device which will create a vacuum condition within a vacuum container and having a vacuum conduit to air convey or transport solid particles and or liquids into the vacuum container. The vacuum container arrangement may also facilitate the separation of solids from the vacuumed air flow by producing a circular cyclone effect within the vacuum container.

2. Description of the Prior Art

Current state of the art mobile vacuum boring, and excavation systems are large and cumbersome, having an engine, a vacuum pump, a stand alone air water separator tank, a stand alone large air bag house filter, a stand alone air cyclone apparatus, and a stand alone vacuum container all mounted individually on the surface of a trailer or truck bed with inter connecting vacuum hoses to each component. Basically, it is a large and unsightly spider web of hoses & equipment. Length and width of the packaged unit is important to access work areas in congested areas & cities. The vacuum container has the ability to be filled and store liquid and solid particles. Currently, vacuum containers capable of vacuuming mud and boring earth are operated as a batch process. The vacuum container is mounted horizontal and filled with solids or liquid. After it is full of solids or liquid a hydraulic jack inclines the tank for unloading. Because of inclining the vacuum container for unloading, even longer interconnecting vacuum hoses are used to connect stationary equipment to the inclinable vacuum container. An operator climbs up on the truck or trailer bed, drains water from the air/liquid separator and then vertically lifts the filter bag with it's dirt from it's housing, shakes & hand washes the dirt from the bag filter and then pushes it back down into the housing. This process is dirty, labor intensive & time consuming so the filter does not get proper maintenance.

An objective of the present invention is to provide a means to improve the efficiency of air/solids separation within the vacuum container, improve air filter cleanness by vibrating solids from the air filter during operation, reduce the quantity of component interconnecting conduits, provide user friendly access to the vacuum container and air filter clean out doors and end up with a compact, concentrated weight, vacuum boring and excavation package mounted on a mobile platform.

It is yet another objective of the present invention to provide a means of adjacently mounting an air filter housing above the vacuum container.

It is yet another objective of the present invention to provide a means of adjacently mounting an air filter housing above the vacuum container, and said vacuum container and said air filter housing have a connecting vacuum air flow conduit.

It is yet another objective of the present invention to provide a means of adjacently mounting an air filter housing above the vacuum container, and said vacuum container and said air filter housing having a connecting vacuum air flow conduit and said conduit being located near the rear of said vacuum container (the rear of said vacuum container being the end nearest to the vacuum container access door 12), and said height of said filter housing giving vertical space to extent said conduit a distance above the top of said vacuum container. There are several advantages to the conduits location near the back of said vacuum container: 1. When the mobile vehicle stops, liquid in the vacuum tank will be pushed away from the conduit instead of being sloshed up through the conduit and into the filter housing. 2. Solids and liquid being vacuumed into the vacuum tank from the rear of the vacuum tank will be propelled by vacuum air velocity past said conduit.

The advantage of the extra conduit height within the filter housing above the vacuum tank is to: 1. Serve as a stand pipe above the vacuum container liquid in order to reduce the risk of the liquid sloshing out through the conduit. 2. To allow the lower volume of the filter housing to serve as a liquid/air separator.

It is yet another objective of the present invention to provide a means of adjacently mounting an air filter housing above the vacuum container, and said vacuum container and said air filter housing have a connecting vertical vacuum air flow conduit and the lower end of said conduit having a seal and float ball to serve as a high liquid level shut off in order to stop the vacuum air flow to the filter housing when the vacuum container is full of liquid and or solids.

It is yet another objective of the present invention to provide a means of adjacently mounting an air filter housing above the vacuum container and said air filter housing and said vacuum container share a common connecting wall.

It is yet another objective of the present invention to provide a means of adjacently mounting an air filter housing near the vacuum container and said air filter have air filter disposed within it.

It is yet another objective of the present invention to provide a means of adjacently mounting an air filter housing above the vacuum container and said air filter housing having an air filter disposed within it and said filter housing having an access door adjacently mounted near to said vacuum container access door.

It is yet another objective of the present invention to provide a means of adjacently mounting an air filter housing near the vacuum container and said air filter having an air filter disposed within it and said filter housing having an access door to remove solids and to give access to wash said filters with a pressurized spray nozzle.

It is yet another objective of the present invention to provide a means of adjacently mounting an air filter housing above the vacuum container and said air filter have an air filter disposed within it and to have an air vacuum conduit connecting a vacuum producing devise to said air filter and a 4 way valve arrangement may be placed in said air vacuum conduit between the filter housing and the vacuum producing means for the purpose of reversing the direction of air flow temporally for the purpose of back flow cleaning of said air filters.

It is yet another objective of the present invention to provide an air compressor to provide a volume of pressurized air to be used in loosening dirt so that the earthen material will be more vacuum able.

It is yet another objective of the present invention to provide ample air solids separation in order to precipitate the solids into the vacuum container so that they may later be emptied from the vacuum container and be used to refill excavated holes with pack able dirt and earthen material.

It is yet another objective of the present invention to provide a means of adjacently mounting an air filter housing above the vacuum container and said air filter have an air filter disposed within it and to have an air vacuum conduit connecting a vacuum producing devise to said air filter and said air vacuum conduit have a sealed disconnect positioned so as to allow temporary disconnecting of said filter housing from said vacuum producing means for the purpose of tilting said vacuum container to remove solids.

It is yet another objective of the present invention to provide a means to accomplish a compact, concentrated weight, vacuum boring & excavation system by mounting a vacuum container at a sufficient incline to allow solids to be emptied out by gravity and to provide space beneath said vacuum container to locate a water storage container.

It is yet another objective of the invention to provide a means of separating the stored contents by predetermined category and dispensing them without stopping the vacuum fill and store operation or eliminating the vacuum environment within the vacuum container.

It is yet another objective of the present invention to provide a means of separating the stored contents by predetermined category and dispensing them without stopping the vacuum fill and store operation or eliminating the vacuum environment within the vacuum container.

It is yet another objective of the present invention to provide an articulated powered vacuum conduit boom with sufficient structural strength to allow an operator to move and control the location of the suction end of the vacuum conduit and said suction end of said vacuum conduit have an earth digging bucket mounted adjacent it, and said conduit boom with said earth digging bucket being mounted on a mobile vehicle, and a preferred vehicle being a powered zero turn radius vehicle having the ability to be converted into a tow able trailer configuration for the purpose of transporting from job to job.

It is yet another objective of the present invention to provide a vacuum conduit boom with sufficient structural strength, power and articulated movement to allow an operator to move and control the location of the suction end of the vacuum conduit into a manhole lateral line along with a jetter spray nozzle.

It is yet another objective of the present invention to provide a powered articulated boom with sufficient structural strength to allow an operator to remotely move, control and stabilize the location of a tool attachment end of said boom within one or more tools may be adjacently attached to the tool attachment end of said articulated boom and said tool is selected from the group consisting of an earth digging bucket, a telescoping vacuum conduit, a sensor to locate buried utilities, a monitors and controls for operating the attachments and their function, a water spray nozzle, a manhole cover remover, a cutting tool, a grinding tool, a saw, a blasting tool, a surface cleaning tool, a demolition tool, a torque wrench, a tractor to pull vacuum hose, a jetter nozzle, a hose reel, a cord reel, a cable reel, and a camera and power source to operate it.

It is yet another objective of the present invention to separate hydrocarbons from the contents vacuumed into the vacuum container.

It is yet another objective of the present invention to provide a means to purify or sterilize the contents vacuumed into the vacuum tank.

It is an objective of the present invention to provide a mobile equipment means for servicing and repairing in ground utilities wherein the mobile equipment means comprises a mobile platform which may be quick coupled to a front loader skid steer type vehicle wherein the mobile platform may have a vacuum excavator system, a water jetter system, an air excavator system, a fire hydrant tester to include a water presser dissipater and water diffuser which may also include a dechlorinator, or an articulated boom arm with utility servicing tools attached mounted on it.

It is yet another objective of the invention for the utility servicing and repair event to be documented. The mobile platform mounted systems may have sensors to measure the physical quantities of the service or repair operation. A data logger, a PLC, an RFID, a camera, a GPS, a utility mapping program, blue tooth transmitting technology, and wireless communication may be used for documenting, controlling, displaying and storing data related to a utility servicing or repair operation or the like. Graphs, pictures, graphics, and charts relative to the service event may be generated for persons with a need to know.

It is yet another objective of the invention to position an RFID means adjacent to an in ground utility valve, valve stem, tee, junction point, service area, access area, or the like for the purpose of locating, identifying data, verifying information, storing information, retrieving information, or the like, relative to a utility item, function, service or the like.

It is yet another objective of the invention to manufacture a valve stem adapter with an RFID means adjacently positioned on said valve stem adapter.

It is yet another objective of the invention to manufacture utility fittings such as a tee, an ell, a flange, a valve, or the like, having an RFID means adjacently positioned on said utility fitting.

It is yet another objective of the invention to position a valve stem adapter on the valve stem of a utility valve wherein said valve stem adapter contains an RFID means.

It is yet another objective of the invention to transmit and or receive data or information to or from an RFID means which has been positioned adjacent to a utility.

It is yet another objective of the invention to locate a air inlet hole near the suction end of the vacuum conduit for the purpose of insuring that air conveying does not stop when the suction end of the vacuum conduit is clogged. It is another objective to place a check valve over said hole which will open at a predetermined vacuum.

It is yet another objective of the invention to position a vibrator means adjacent to the suction end of a vacuum conduit for the purpose of loosening earthen material and improving it's vacuum ability. It is yet another objective to use the vibrator simultaneously with a pressurized air excavation nozzle, where both work in communication with the other to expedite the rate of excavation.

It is yet another objective of the invention to add water to pressurized air which is being used for air excavation. It is yet another objective of the invention for said water to add mass said air. It is yet another objective of the invention for the ratio of said water to said air to be regulated to a predetermined amount for establishing a predetermined excavation efficiency. It is yet another objective of the invention for said water to said air ratio to be regulated to accomplish a predetermined ratio of dust and mud.

It is an object of the present invention to provide a vehicle mounted vacuum excavation system with a vacuum hose reel pivot ably mounted adjacent to a vacuum container and the vacuum hose reel allowing the vacuum hose to be used for vacuuming up solids or liquid while the vacuum hose is still partially rolled up on the vacuum hose reel and the vacuum hose reel being able to retract or dispense a length of vacuum hose as needed in order for the suction end of the vacuum hose to be placed near vacuum able solids or liquids.

It is an object of the present invention to provide a vehicle mounted vacuum excavation system with a vacuum hose reel pivot ably mounted adjacent to a vacuum container and said vacuum container also adding structural support to said pivotably mounted vacuum hose reel and the pivot ably mounted vacuum hose reel having a means to rotate said hose reel in order to retract or dispense a length of vacuum hose as needed in order for the suction end of the vacuum hose to be placed near vacuum able solids or liquids and said means of rotating said hose reel being chose from a group consisting of a handle for manually rotating said hose reel, an electric motor, a hydraulic motor, an air motor, a vacuum motor, or the like.

It is an object of the present invention to provide a vehicle mounted vacuum excavation system with a vacuum hose reel pivot ably mounted adjacent to a vacuum container and the pivot ably mounted vacuum hose reel having a means to rotate said hose reel in order to retract or dispense lengths of vacuum hose as needed in order for the suction end of the vacuum hose to be placed near vacuum able solids or liquids and said means of pivot ably attaching said vacuum hose reel to said vacuum container being chosen from a shaft with a bearing plate, a hollow shaft with bearing and a seal, and a slewing ring gear drive such as a Model S-7 hourglass worm slew drive made by Kinematics Mfg. Inc.,

Another object of this invention is to have a pivot able mounted articulated boom means which will allow an operator to move a reel to a desired position within a three dimensional space adjacent to the base to which the articulated boom arm is attached and said reel being chosen from a group consisting of a conduit reel, hose reel, a power cord reel, a fiber optic reel, a rope reel, and a cable reel.

It is an object of the present invention to use a slewing ring gear drive as the bearing support and rotational axis means to articulate the boom arm in relation to the mounting base on the mobile vehicle. An example of a slewing ring gear drive could be a Model S-7 hourglass worm slew drive made by Kinematics Mfg. Inc.

It is an object of the present invention to power a slewing ring gear drive with a hydraulic motor or electric motor.

It is an object of the present invention to use a motor to wind the reel and it is an objective of the present invention to monitor and document the torque required to turn the reel.

It is an object of the present invention to have a sensor means to monitor the length of cable or hose that is dispensed from the reel. A sensor means can measure and count the feet or units lengths of cable or hose as it is being dispensed and rewound onto the reel.

It is an object of the present invention to position sensors and transmitters adjacent to the reel to allow wireless communication and control of data associated with the operation and interaction of equipment and the utilities.

It is an object of the present invention to provide a vehicle mounted vacuum excavation system and water jetter system, with a vacuum hose reel pivot ably mounted adjacent to a vacuum container and the pivot ably mounted vacuum hose reel having a means to rotate said hose reel in order to retract or dispense a length of vacuum hose as needed in order for the suction end of the vacuum hose to be placed near vacuum able solids or liquids and said vacuum hose having an articulated support means pivot ably mounted adjacent to a jetter hose reel.

### SUMMARY OF THE INVENTION

The above described objectives and others are met by a method having a vacuum container arrangement which may also facilitate the separation of solids from the vacuumed air flow by producing a circular cyclone effect within the vacuum container. The circular cyclone affect is generated by an inlet vacuum conduit entering the vacuum tank on the same end as the solids unloading door is located (being the back end of the vacuum container) and being the same end near to the conduit that conveys air from the vacuum container to the air filter. By extending the inlet vacuum conduit to a point just past the conduit that conveys air from the vacuum container to the filter and pointing the open end of the inlet vacuum conduit toward the vacuum container end opposite the solids unloading door (being the front end of the vacuum container), the velocity of the air flowing through the inlet vacuum conduit will propel any solids or liquid it is conveying to the front end of the vacuum container. Also the cross sectional area of the vacuum container is many times more than the cross sectional area of the inlet conduit, thus the velocity of the conveying air is also substantially reduced (as in a circular cyclone solids separator devise), thus the solids and liquid precipitate out of the air flow and settle on the bottom of the vacuum tank. The velocity of the conveying air slows even more as it reverses direction in a circular motion in order to exit the vacuum container and enter the filter housing through the exit conduit located near the back of the vacuum container. Thus performing a cyclone effect of circling and slowing the air velocity to facilitate removing a maximum of solids and liquid from the air before the air reaches the air filters. A baffle may be arranged around the inlet conduit that flows air from the vacuum container to the filter housing. This baffle may also be arranged so as to create an additional cyclone environment for further separating solids from the air. A housing with filters is adjacently mounted above the vacuum container in order to reduce the quantity of connecting conduit and facilitate a compact, efficient and clean interaction between the vacuum container and the filter housing. The filter housing and the vacuum container may share a common dividing wall. A 4 way valve arrangement may be used between the filter housing and the vacuum producing means to reverse the direction of air flow temporally for the purpose of back flow cleaning of the air filters. A compressible seal and conduit arrangement may be used as a quick disconnect between the vacuum producing means and the filter housing. The vacuum container access door and the filter housing access door may be adjacently placed in near proximity to each other for user friendly access to empty and clean the vacuum container and filter house. By inclining the vacuum tank and filter housing, they may be emptied by gravity. Vibrating the air filters creates a self cleaning effect. The vibration of the air filters may be created for example, by using tubular air filters that are mounted to the filter housing only by one end. Each movement of the vacuum filter housing vibrates solids from the filter and stores the solids in the filter housing until the housing is inclined and the access door is opened for emptying and cleaning. A pressurized water wash wand may be extended through the access door to wash the air filters. A baffle mounted within the filter housing adjacent to the filter housing air inlet conduit facilitates the efficiency of air flow & reduces sloshing of liquids into the air inlet conduit during mobile travel. The filter housing may also be designed to temporally store quantities of liquid carried over from the vacuum container, thus reducing the risk of liquid flowing through the filter to the vacuum pump. A vacuum conduit seal connector can be used to connect vacuum hoses that need to be separated temperately during the process of emptying solids from the vacuum tank. This invention generates an efficient compact mobile vacuum system having a minimum of interconnecting vacuum hoses to convey air from one step of the process to the next. Stacking the filter house above the vacuum container, reduces the square feet of mobile floor surface area requires to mount all the equipment. In other words this invention allows all the required equipment to be mounted on a skid, trailer or truck bed that is shorter and or more narrow than conventional state of the art equipment. In addition to reduced size, the invention has the advantage of operating more efficiently, have a cleaner, more simplistic look, be easier to perform maintenance on and even be more efficient to manufacture at a completive cost. The vacuum container may also have a means to separate a liquid from solids and dispense them from the vacuum container without eliminating the vacuum environment within the vacuum container.

The vacuum conduit used to transport debris into the vacuum container may have the added feature of being mounted on a powered remote operated articulated boom with sufficient structural strength to allow an operator to remotely move and control the location of the suction end of the vacuum conduit and may have one or more attachments adjacently attached to the boom arm or to the suction end of said vacuum conduit and said attachments being chosen from an earth digging bucket, a telescoping vacuum conduit, sensor to locate buried utilities, monitors and controls to operate the attachments and their function, water spray nozzle, vibrator, manhole cover remover, cutting tool, grinding tool, saw, blasting tool, surface cleaning tool, demolition tool, torque wrench, tractor to pull vacuum hose, jetter nozzle, or camera and power source to operate them.

This invention also includes the use if the described tool used in conjunction with each other and with or without the vacuum container. Such as a skid mounted, powered, remote control, articulated boom with an attached tool such as a torque wrench; and also having a fire hydrant system tester, a water diffuser and a de chlorinator as part of the skid mounted water utility servicing system and also having a quick coupler for attaching the skid mounted utility servicing system to the front loader arm of a skid steer.

The above described vacuum system may be mounted on a variety of mobile platforms, chosen from but not limited to a trailer, truck, skid steer, fork lift, track hoe, railroad car, air craft, space craft, boat, barge or zero turn radius vehicle which may have the added feature of being convertible between a powered vehicle & a trailer.

### BRIEF DESCRIPTION OF THE DRAWINGS

FIG. 1 shows a vacuum container according to a first embodiment of the invention having both liquid and solid dispensers and means disposed within the container to separate liquids from solids.

FIG. 2 shows a side elevation of a vacuum container according to a second embodiment of the invention using a screen cylinder to separate liquids from solids and having a pump dispenser disposed within the screen and having a vibrator attached to the screen. Purification means are disposed within the vacuum container to remove contaminants from the liquids or solids. Purification means 55, hydrocarbon absorbing means 56 and sterilization means 57 are shown disposed within the vacuum container although they can be attached to the container or conduits. Purification, hydrocarbon absorbs ion or sterilization means may chosen from, but are not limited to, zealite, ozone or activated carbon or ultra violet light or phasing or ultra sonic or chlorine or peat or diatomaceous earth.

FIG. 3 shows a vacuum container and liquid dispenser according to the second embodiment of the invention using a powered boom to articulate the vacuum conduit with vacuum conduit suction end attachments, sensors & controls.

FIG. 4 shows a vacuum container with liquid and solid dispensers according to a third embodiment of the invention using an articulated vacuum and jetter boom to reach into a lateral line of a drain pipe. A vacuum conduit tractor is shown pulling a vacuum conduit & the tractor is shown with a rotating vacuum nozzle, controls, light and camera. A jetter is also shown loosening debris to be vacuumed. The vacuum container is shown to separate solids & liquids. The liquid is shown to be dispensed and recycled. The solids are shown to be ground to a smaller size, and transported to a mobile container.

FIG. 5 shows a skid steer attachment being a platform with a vacuum excavation system, a water jetting system, a performance measuring, monitoring, data storage and documentation system, and an articulated boom arm system with tools attached to it and the tools are supported by the boom and secured in place during a service event such as exercising a valve or doing a repair to an in ground utility.

FIG. 5B is a side view of a skid mounted fire hydrant testing system quick coupled to a skid steer.

FIG. 6 is a side view of a vacuum hose guider support which is shown to be supported by a pivot ably mounted, articulated hose guider support boom arm, and said pivot ably mounted, articulated hose guider support boom arm is shown to be mounted adjacent to a jetter hose reel. The vacuum hose guider support can be a length of conduit or it can be a sleeve that the vacuum hose slides through or it can be an arrangement of rollers that serve to support and or guide the vacuum hose. Said rollers may be idler rollers or driven rollers used to assist in dispensing or retracting the vacuum hose. The suction end of the vacuum hose is shown to be vacuuming solids 45 or liquid 2 from a utility man hole basin 59.

FIG. 6B is an end view of a vacuum hose reel which is shown to be pivot ably mounted adjacent to a vacuum container, but said vacuum hose reel is shown to be supported on a mobile vehicle platform by a vacuum hose reel support. A vacuum conduit connector is shown to connect the ridged vacuum conduit pipe to the vacuum conduit piping of the rotate able mounting attachment. The vacuum conduit connector can be a ridged fixed connector or it can be a quick release connector or a compression type seal connection which will separate in order to allow a vacuum container to be raised for unloading solids.

FIG. 7 shows an articulating boom with a multiple conduits 72 reaching into a drainage pipe lateral line to loosen & vacuum debris from the drainage pipe. The earthen material is vacuumed into the vacuum container and then conveyed out of the vacuum container via a screw conveyor 10. At the discharge end of the conveyor 10 the discharge air from the vacuum producing means 11 is utilized to further convey the earthen materials 35 or debris 45 through a solids dispensing conduit boom. An air nozzle/orifice arrangement means 69 is illustrated as a means to direct the flow of air which is used to convey solids.

FIG. 8 shows an inclined slope vacuum container supported by a liquid storage container mounted under the slope of the vacuum tank. A filter housing containing filters is shown mounted adjacent to the debris tank. A single door is shown to access both the filter house and the debris tank simultaneously. A solids liquid vibrating screen separator is shown mounted to the debris tank portion of the access door. A powered telescoping cylinder or linear actuator is shown to open or close the access door. A powered articulating vacuum boom is shown with a manhole cover removal attachment.

FIG. 9 Shows a cross sectional view of an earth excavator digging a hole in the earth using a vacuum container mounted on a zero-turn radius vehicle & having a solids and liquid separation and unloading means. The Vacuum container is shown connected to an articulated vacuum conduit boom with an earth digging bucket attached in the retracted position. A telescoping section of the vacuum conduit is shown in the extended position vacuuming dirt that has been by water sprayed from a liquid spray nozzle which is shown mounted in the outside circumference of an indention in the suction end of the vacuum conduit. The indention reduces the size of solid that can enter the vacuum conduit, thus reducing the frequency of solids being clogged in the vacuum conduit. The earth excavator is shown to be convertible between a zero turn radius vehicle and a tow able trailer. The excavator is shown in the excavating configuration with the spreader blade being used as a jack. The debris access door is shown opening by a powered telescoping cylinder which in turn moves the pull bars and dried dirt out of the vacuum tank.

FIG. 10 Shows the earth excavator configuration as a trailer attached behind a truck. The trailer hitch has been lowered & the swivel front wheels have been raised. The articulated vacuum boom has been configured into a stored position and the combination dirt pushing blade and jack has been raised. A powered articulated boom is illustrated as mounted adjacent to the vacuum container and air filter housing. Said boom is illustrated to have a torque wrench tool 32 coupled to the attachment means of the telescoping boom arm. The hydraulics which could power the torque wrench tool are illustrated as supplying hydraulic power to a hydraulic driven submergible pump which has been lowered into a pit of water by the powered articulated boom arm. The water is being pumped from the pit by said submergible pump 7. The pit could be a lift station such as a waste water utility lift station. A Jetter 26 or 39 could be used to break up any surface solids or a grinder pump 27 could be added to grind up solids so that they would be small enough to pump out or to vacuum up.

FIG. 11 shows a cross sectional side view of a trailer mounted vacuum excavator and surface cleaner with the filter housing 64 mounted above the vacuum container 12. An air conduit 13C allows air to flow from the vacuum container 12 to the filter housing 64 and then the air 77 flows through the air filter 65, the air conduit 13, through the conduit disconnect seal assembly 83 & 84. The air 77 is then shown passing through a 4 way diverter valve 81 which may be used to temporarily reverse the flow of air back through the air filter 65. The air flow reversing is important to assist in cleaning dirt from the filter 65 by blow dirt from the filter 65 to the cavity of the filter housing 64. This process is especially useful when vacuuming dusty dry solids such as during the process of using air under pressure for excavating dirt. Vacuum suction hose 17 is shown vacuuming solids 6 into the vacuum container 12 through it's rear wall. This side elevation shows the air path and depicts the cyclone effect created by locating both the conduit 13C and the vacuum hose 17 discharge adjacent to each other as well as being adjacent to the vacuum tank rear access door 12. The air 77 is shown to slow in velocity, change directions and precipitate the solids it has been carrying adjacent to the bottom front of the vacuum container. The air filter housing 64 and the vacuum container 12 are also shown to be separated by a common dividing wall.
An air compressor 101 is shown to receive air 77 through an air filter 102. The air 77 flows through conduit 103, then through air compressor 101 then through conduit 104 then through air nozzle 105 just before air 77 impinges the earthen material 35 thus making the earthen solids 6 more vacuum able.

FIG. 12 shows a cross sectional end view of a trailer vacuum excavator like is shown in FIG. 14. This view allows a better visualization of the relation ship between the air conduit 13C, and the high level vacuum shut off ball 79. The baffle 78, the rear vacuum hose inlet 17, an end view of the air filters 65 orientation relation ship is also shown. The air flow 77 is also shown dropping solids 6.

FIG. 13 shows a cross sectional top view of a trailer vacuum excavator like is shown in FIG. 14. This view allows a better visualization of the relation ship between the air conduit 13C, and the rear vacuum hose inlet 17, and the air filters 65. The air flow 77 is also shown dropping solids 6.

FIG. 14 shows a trailer 31 vacuum excavator side view with the vacuum tank laying horizontal during the process of filling it with solids or liquid. The air filter housing 64 is shown mounted horizontally above the vacuum container 12. The filter housing door 18F and the vacuum container rear access door 18 are both shown in the closed position during the vacuum filling of the vacuum container 12. Vacuum filling hose 17 is shown to be vacuum air conveying solids 6 from the ground 35 into the vacuum container 12. Water storage container 8 is shown as a saddle tank mounted adjacent to the trailer 31 finders & wheels.

FIG. 15 shows a trailer 31 vacuum excavator side view with the vacuum container 12 temporally raised to an inclined position for the purpose of unloading solids 6 from the vacuum container 12. The vacuum container 12 read door 18 is shown in the open position with solids 6 flowing from the vacuum container 12. The filter housing 64 rear access door 18F is shown emptying solids 6. The rear access door 18F gives access to empty solids from the filter housing 64 by gravity as well as giving the operator a user friendly access to the air filters 65. The open rear access door 18F gives the operator easy access to insert a pressurized water nozzle within the filter housing 64 in order to wash clean both the air filters 65 and the filter housing 64. The wash water and dirt flow freely by gravity from the filter housing 64. The vacuum container can also be washed clean by the operator using a pressurized water nozzle & gravity. Permanent wash nozzles way be mounted and piped into the filter housing 64 or vacuum container 12. Remote controls can be used to operate the water nozzles.

FIG. 16 shows a trailer mounted vacuum excavation machine EPI per the present invention showing its vacuum conduit 17 connecting a vacuum container 12TP. The vacuum tank 12TP is shown mounted on a trailer 30TP being pulled by a truck 70. Vacuum container 12TP is shown getting it's vacuum source through conduit 17. Conduit 17TP is shown vacuuming earthen material 35 into the vacuum container 12TP. Water 2 under pressure is shown passing through water conduit 5 & through water spray nozzle 26 in order to impinge the earthen material 35 and make it vacuum able. Vacuum excavation machine EPI is shown supplying the power, vacuum source, and pressurized water supply for the excavation. The larger vacuum container 12TP is shown as a storage container for vacuumed solids & liquid. When it is filled, it will be hauled off to an unloading location by truck 70. The EPI vacuum excavator will remain in place ready to fill another 12TP vacuum container. Thus this arrangement functions like a track loader filling a dump trucks with dirt.

### SOME DEFINITIONS

31—Mobile Platform—a moveable or transportable surface which may be used to support Things.
32—Attachment tools—a tool which may be attached to something. Such as a tool that is attached to a boom arm
33—Utility Sensor—an earth penetrating means for locating a buried utility
34—Monitor and for Controller, which may include but not be limited to a GPS signal receiver, an RFID, a data logger, a PLC, a sensor, a wireless transmitter, a touch-screen interface, a phone, internet connection, a camera, or the like.
37—Reel—is an object around which lengths of another material (usually long and flexible) are wound for storage. Generally a reel has a cylindrical core and walls on the sides to retain the material wound around the core.
74—Skid Steer type vehicle—a skid steer is a vehicle maneuvered by skid steering, a method of steering through braking or engaging tracks or wheels on one side of a vehicle. The skid steering vehicle is turned by generating differential velocity at the opposite side of the vehicle, as the wheels or tracks are non-steer able. Skid steers can pivot steer which is the ability to change direction on the same place without going through any distance in forward or reverse direction. A zero turn radius vehicle and a skid loader are also a skid steer.
177—a standard predetermined type skid steer quick connect type receiving attachment fastener means for connecting implements to a skid steer
178—Lifting arm such as that of a skid steer or front loader.
184—Hydraulic quick connects and associated hydraulic hoses.
88—(Wireless communication) is the transfer of information over a distance without the use of electrical conductors or wires. It includes antennas for transmitting and receiving information.
89—(GPS)—is any devise that receives Global Positioning System signals thus the devise may be known as a GPS signal receiver. The GPS signals include data which is use full to locate a present location, which may include time, latitude, longitude and elevation. The GPS signal receiver system may be hand held or mounted on the platform 31.
90—(RFID)—Radio-frequency identification is the use of an object (typically referred to as an RFID tag) applied to, incorporated into a product, or applied by a person for the purpose of identification using radio waves. Most RFID tags contain at least two parts. One is the integrated circuit for storing and processing information, modulating and demodulating a radio-frequency (RF) signal, and other specialized functions. There are generally three types of RFID tags, which contain a battery and can transmit signals autonomously, passive RFID tags, which have no battery and require an external source to provoke signal transmission, and battery assisted passive (BAP) which require an external source to wake up but have significant higher forward link capacity providing great read range. Item 90 RFID includes using the type RFID tag best suited for the specific field application. The RFID tag may be hand held or mounted on the platform 31. The RFID tag may be mounted on a utility access opening, at a repair location, at a buried valve, mounted as part of the valve stem, valve stem adapter or the like for the purpose of finding an in ground valve, a junction point, a repair location or identifying information relative to a utility item, it's performance, maintenance history or the like.
91—RFID antenna—for receiving and transmitting the signal. The RFID antenna may be hand held or mounted on the platform 31.
92—Data Logger—is an electronic devise that records data over time or in relation to location either with a built in instrument or sensor or via external instruments and sensors. Increasingly, but not entirely, they are based on a digital processor (or computer). The data logger may be small, battery operated, portable, or equipped with a microprocessor, internal memory for data storage, or sensors. The data logger may interface with a personal computer and utilize software to activate the data logger and view and analyze the collected data, or may have a local interface device (keypad, LCD) and can be used as a stand-alone device. One of the benefits of using the data logger is the ability to automatically collect data even on a 24-hour 7-day bases. Upon activation, the data logger may measure and record information for the duration of a monitoring period. This allows an accurate picture of the conditions being measured, such as RFID info.; GPS info.; hydraulic flow, pressure or temperature; water flow, pressure or temperature; air flow, pressure and temperature; evaluate process equipment system measurements against predetermined conditions and standards. A USB flash memory data storage device may be used for data storage. The data logger may include or be coupled to a display and soft ware in order to display gathered data in a meaningful, user friendly manor. The data logger may be hand held or mounted on the platform 31.
93—(PLC)—programmable logic controller—is a digital computer used for automation of electromechanical processes, such as opening or closing valves or turning switches on or off based or predetermined measurements. A PLC is a real time system wherein output results are produced in response to input conditions within a boundary time. The PLC may be hand held or mounted on the platform 31.
94—Sensor—a sensor is a device that measures a physical quantity and converts it into a signal which can be read by an observer or by an instrument such as a data logger, PLC or the like. Examples of a sensor included but are not limited to a volt meter, an amp meter, a flow sensor, a pressure sensor, a temperature sensor, a level sensor, a speed sensor or the like.
95—Hand held electronic device. Is an electronic device which may be held in the hand of an operator. It may be a type of (PDA) Personal Digital Assistant which may include but not be limited to a GPS signal receiver, an RFID, a data logger, a PLC, a sensor, a wireless transmitter, a touch-screen interface, a phone, internet connection, a camera, or the like. It may be keep by the operator person or stored on the mobile platform.
96—Camera—is a device that records images, either as a still photograph or as a moving image known as a video or movie. The camera may work with the visual spectrum or with other portions of the electromagnetic spectrum.
97—Utility Mapping System—to include a GIS Mapping system—A Geological Information System captures, stores, analyzes, edits, manages, displays and presents data that links to location, to include a utility piping system displayed relative to geographic information. It includes merging of cartography and database technology. A GIS is a system which includes mapping software and its application to remote sensing, land surveying, water utility piping system surveying, aerial photography, mathematics, photo grammetry, geography, and tools that can be implemented with GIS software.
98—Utility Valve—generally an in ground water valve
99—Valve stem—generally the portion of a valve which is turned in order to open or close a valve.
100—Valve stem extension rod—which may be telescoping.
120—Water diffuser—a tool used when testing a fire hydrant for receiving pressurized water from a fire hydrant. The diffuser is configured so as to discharge the water it receives at a pressure and velocity that is less than the pressure and velocity at which the water entered the diffuser. The effectiveness of the diffuser is improved by improving the reduction of pressure or velocity.
121—De Chlorinator—is a means for removing a chlorine chemical from water.
Data—means groups of information that represent the qualitative or quantitative attributes of a variable or set of variables. Data are typically the results of measurements and can be the basis of graphs, images, or observation of a set of variables. Data are often viewed as the lowest level of abstraction from which information and knowledge are derived.
Document—is to present data in a file or format which may be useable for representation of a body of information. To document (verb) is to produce an artifact of data by collecting and representing information.

### DETAILED DESCRIPTION OF THE PREFERRED EMBODIMENTS

Using the drawings, preferred embodiments of the present invention will now be explained.

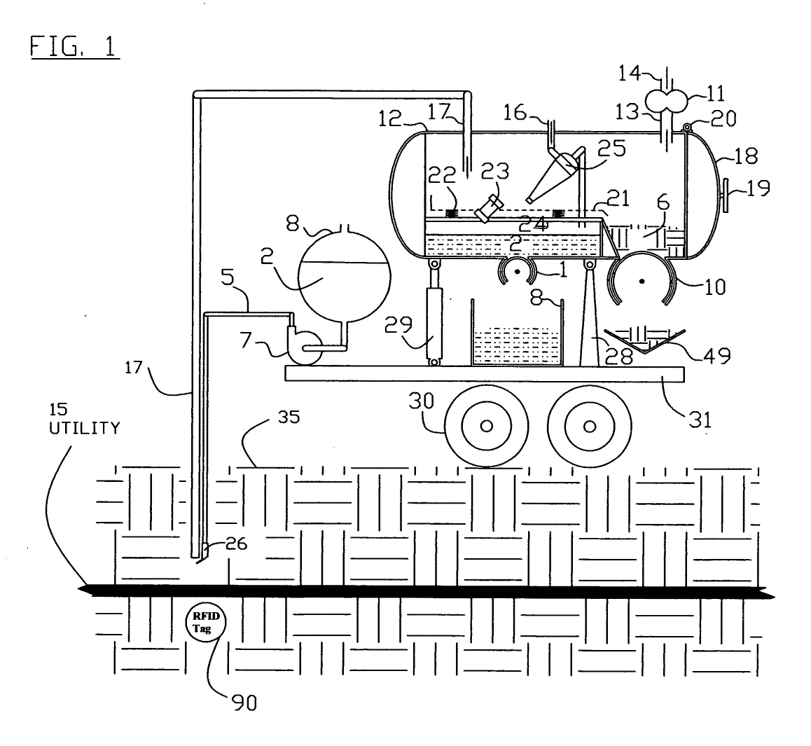

FIG. 1 shows the first embodiment of the invention, being one example of various possible arrangements of apparatus within a vacuum container 12 for the purpose of accomplishing a method of separating solids 6 or liquids 2 by predetermined category and then dispensing said solids 6 or liquids 2 using a dispensing means 1 without eliminating the vacuum environment within the vacuum container 12. In FIG. 1, the apparatus of the present invention include a vacuum container 12, a vacuum producing means 11, a conduit 13 to allow air to move from vacuum container 12 to vacuum producing means 11, a second conduit 14 dispenses air from the vacuum producing means 11. Vacuum container 12 has an access door 18 having a hinge 20 and a latching means 19. Solids 6 or liquids 2 are vacuumed into vacuum container 12 by means of a vacuum conduit 17. In FIG. 1, the ground 35 is earthen dirt. Liquid 2, which has been stored in container 8, is pumped by pump 7 through pump discharge conduit 5 to a spray nozzle 26. The pressurized liquid 2 dislodges and emulsifies the ground 35 so it becomes vacuum able. The vacuum able ground 35 and liquid 2 are vacuumed through conduit 17 and into vacuum container 12. The solids 6 and liquids 2 fall onto a screen 21 which is vibrated by vibrator 23. Screen 21 is mounted on springs 22 which are supported by support means 24. Liquid 2 passes through screen 21 and is dispensed from the vacuum container 12 by means of a liquid dispenser means 1 which is shown as a rotary void style in this example. The solids 6 which are too large to pass through the vibrating screen 21 are vibrated to a solids dispensing means 10 which in this example is a rotary void style dispenser. The solids 6 are dispensed into solids conveyor 49. The vacuum container 12 is supported by a pivot arm 28 and a cylinder 29 which may be extended to dump contents out of container access door 18. The above system is mounted on a mobile platform 31 with wheels 30. FIG. 1 is shown excavating ground 35 in order to locate a utility 15 without doing damage to said utility 15.

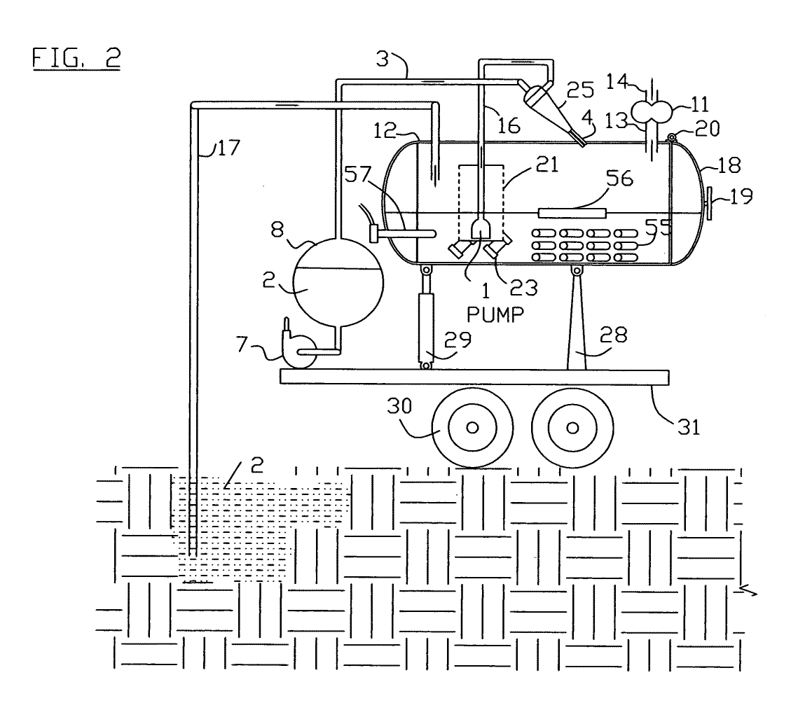

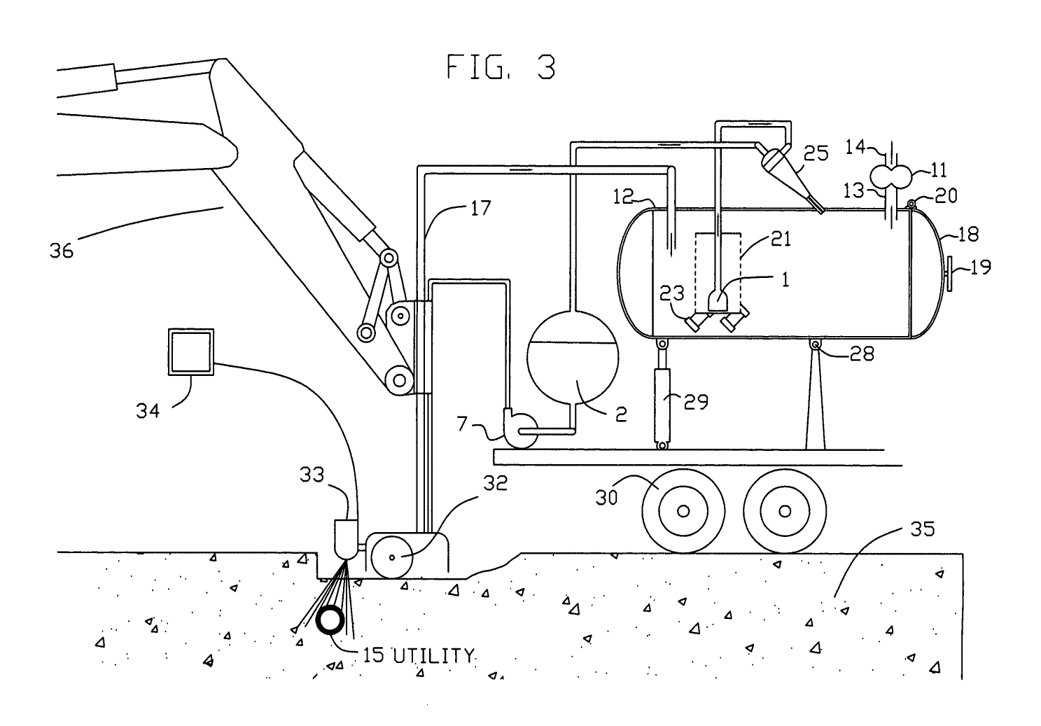

In a second embodiment of the invention shown in FIGS. 2 and 3, the screen 21 is formed in the shape of a cylinder. The solids 6 and liquids 2 which are vacuumed through conduit 17, are deposited into vacuum container 12 around the vibrated screen well 21. The solids 6 which cannot pass through the screen well 21, remain in the vacuum container 12 to be dumped out through access door 18 when it is opened and cylinder 29 is extended. Liquid 2 passes through screen 21 thus dewatering the solids 6 which remain in vacuum container 12. Liquid 2, which passes through screen 21, is dispensed from vacuum container 12 by means of liquid dispenser 1, which in this example is a pump. The liquid 2 passes through conduit 16 and into hydro-cyclone 25 where the solids 6 and liquid 2 separation is further refined. The solids 6 are discharged through solids discharge conduit 4 into vacuum container 12 and liquids are discharged through conduit 3 which discharges into a liquid 2 storage container 8 thus providing a method to reclaim and recycle vacuumed liquids 2. Purification elements 55 such as ozone, activated carbon or zealite, hydrocarbon absorbing means 56 and a sterilization means 57 is located within the vacuum container 12. in order to purify, sterilize or remove hydrocarbons from the liquids 2 or solids 6 as they pass through vacuum container 12. The sterilization means 57, or purification means 55 or hydrocarbon means 56 may also be disposed within the suction conduit 17 or dispensing conduit 16, or dispensing means 1 or 10.

FIG. 3 has the added features of a mobilization means 36 being a powered mobile boom to articulate the movement of vacuum conduit 17 and vacuum conduit attachments 32 which may consist of cutters, demolition means, surface grinders, cleaners, air jets, water jets, scoops, etc. Utility location sensors 33 with monitor/controller means 34 are shown to assist in locating and accessing a utility 15 buried under ground 35 which may consist of dirt, stone, asphalt, concrete or a combination there of. The system of FIG. 3 is shown to also be recycling the liquid 2 as it locates, uncovers or avoids a utility 15.

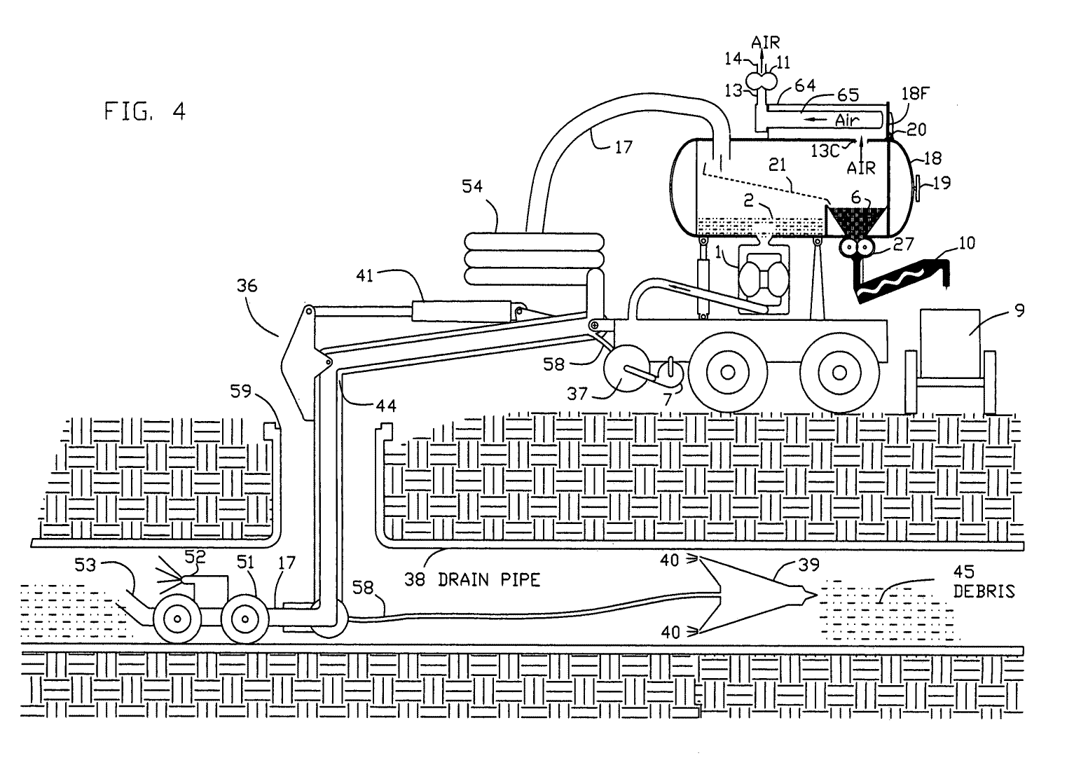

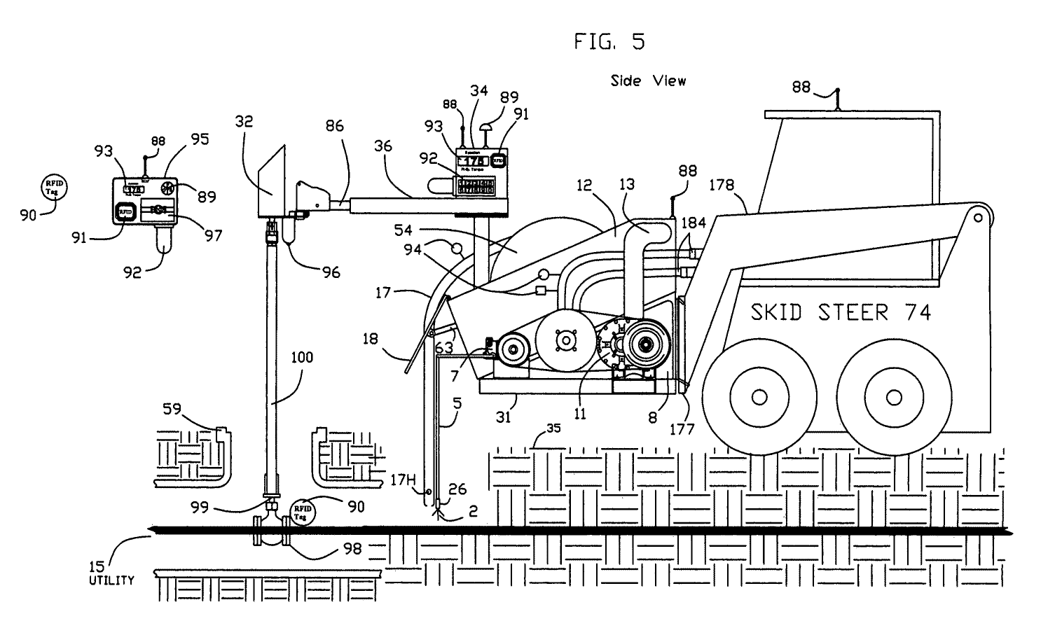

In a third embodiment of the invention shown in FIG. 4, the solids 6 are passed through a solids grinder 27 in order to reduce the solids 6 size to a predetermined size before being dispensed by a solids dispenser 10 which in this example is a progressive cavity screw. The dispensed solids are collected in solids receiver container 9 to be hauled off. The liquid 2 is shown being dispensed by liquid dispenser means 1, which in this example is a diaphragm pump. The recycled liquid 2 is pumped through hose reel 37 by transfer pump 7 to a water jetter 39 spraying a water jet 40, thus cleaning drain pipe 38 with recycled water as it moves.

The recycled liquid 2 along with solids 6 washed from drain pipe 38 are vacuumed up by the vacuum conduit 17 which is shown as an articulated powered vacuum conduit boom 36. The articulated powered boom 36 also has means to place the jetter 39 into location down a manhole 59 and into a lateral drainage conduit 38 and dispense the jetter conduit 58. In this example, telescoping cylinder 41 is used to articulate the vacuum conduit boom 36 and jetter 39. Vacuum boom structure 44 allows the vacuum conduit 17 to be rigid enough to move, support weight and force in order to articulate and operate attachments such as the vacuum conduit tractor 51 which is articulated into a starting position by the vacuum conduit boom 36. Vacuum conduit powered tractor 51 then moves vacuum conduit 17 to debris 45 to be vacuumed. Vacuum hose reel 54 unreels and retracts vacuum hose 17 as needed. Vacuum conduit tractor 51 can have a sensor controller means 52 attached so as to monitor and control the vacuuming process. Vacuum conduit tractor 51 can also be fitted with an articulating suction head means 53, which allows the vacuum conduit tractor to access debris 45 in multiple degrees. Although the articulating vacuum conduit boom 36 is shown vacuuming debris from a drain pipe, said vacuum conduit boom 36 works equally well vacuuming substances from railcars, barges, tankers, silos, or shavings and dung from the barn and stables.

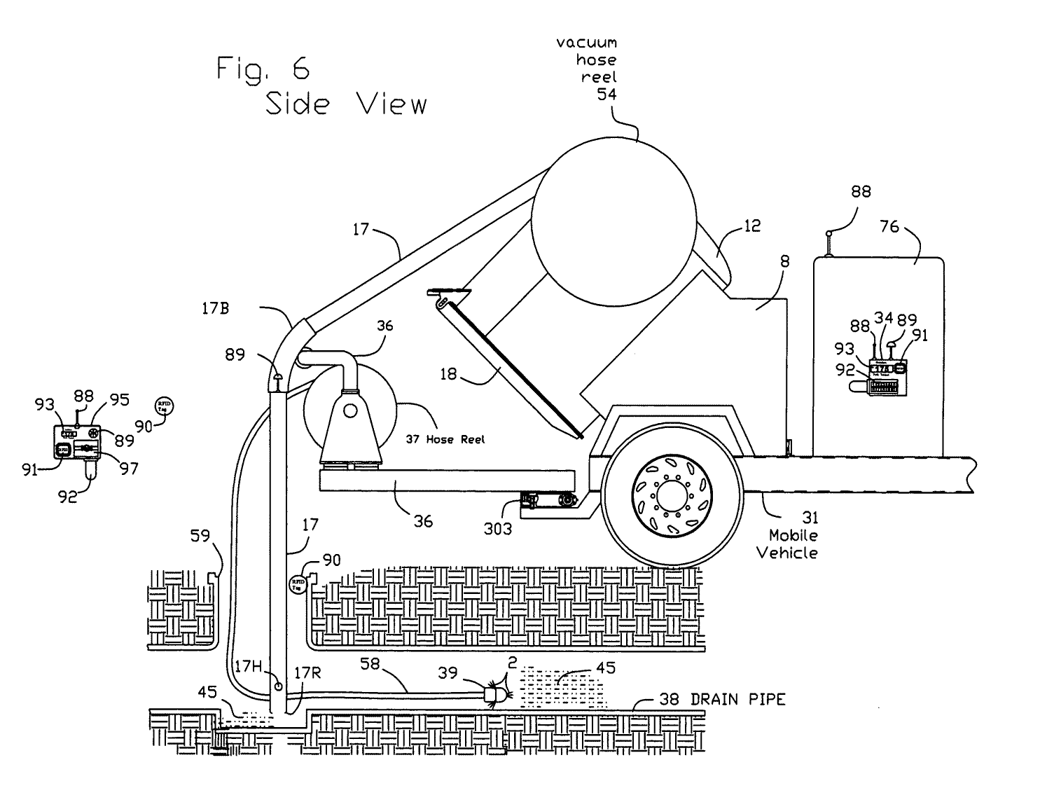

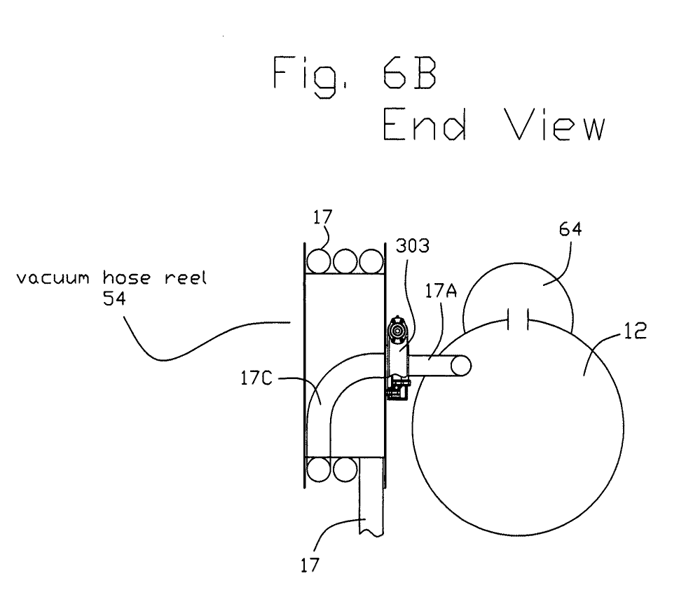

FIG. 6 illustrate the vacuum hose reel 54 rotate ably mounted and supported by a vacuum container 12 and the vacuum hose reel 54 is also illustrated to rotate around a horizontal axis, however the vacuum hose reel 54 could also be mounted to rotate around a vertical axis instead or have an adjustable mount attached in such a way as to pivot said vacuum hose reel 54 from a horizontal to a vertical axis of rotation. The vacuum container 12 is illustrated to be of the incline slope design which is rigidly mounted and does not further incline in order to unload its contents. However, the vacuum hose reel 54 could be rotate ably mounted adjacently to a vacuum container 12 which is filled in a horizontal orientation and then inclined in order to unload its contents. The vacuum hose 17 is shown to be supported and guided by a support guider 17B which is being supported by an articulated arm 36 which is mounted adjacent to a jetter hose reel 37.

FIG. 6B illustrates a cross section end view of a vacuum hose reel 54 pivot ably attached to a vacuum container 12 by means of a ridged vacuum conduit pipe 17A extending from the vacuum container 12. In FIG. 6 the vacuum hose reel 54 is shown to rotate around a horizontal axes. The Vacuum container 12 is shown to give structural support to the ridged vacuum conduit pipe 17A which in turn is shown to give structural support to a rotate able mounting attachment 303 which has bearings and seals. The rotate able mounting attachment 303 is shown to be supporting the vacuum hose reel 54. The vacuum hose 17 is attached to the rotate able mounting attachment 303 by means of vacuum conduit connector 17C. In this drawing, the rotate able mounting attachment 303 with its bearings and seals is shown to be an hourglass worm slewing ring gear drive 303. An electric motor, a hydraulic motor or a handle may be used to rotate the hourglass worm slewing ring gear drive 303 which then turns the vacuum hose reel 54 in order to retract or dispense a length of vacuum hose 17.

FIG. 5 is shown as a side view example of a mobile equipment means for servicing and repairing in ground utilities 15. The mobile equipment means illustrated in this example is a mobile platform 31 which is connected 177 to a front loader lifting arm 178 of a skid steer 74 type vehicle via a skid steer coupling means 177. The skid steer hydraulic system is illustrated as providing the power source for powering the vacuum producing means 11, the water pump 7, and the valve exerciser tool 32 which is attached to an in ground utility valve 98 via an extension arm 100. The mobile platform 31 is illustrated to have multiple utility servicing systems mounted on it, which include a vacuum excavator system, a water jetter system, and a pivot ably mounted articulated boom arm 36 with a torque wrench utility servicing tool 32 mounted on it. In this example the torque wrench 32 is being used to exercise an in ground utility valve 98 via an extension rod 100 which is shown to couple the valve stem 99 to the torque wrench 32. The torque wrench 32 may be used to open and close valves or loosen valve seats, bolts or the like. Camera 96 is illustrated as videoing the servicing of the utility valve 98. The water jettering system is illustrated as supplying water 2 to a spray nozzle 26 for the purpose of improving the vacuum ability of earthen material 35. The vacuum excavation system is illustrated as vacuuming up the earthen material 35 thus creating an access opening to an in ground utility 15. The mobile platform 31 mounted systems are also illustrated to include process control and data documentation sensors 94 to measure the physical quantities of the service or repair operation. A data logger 92, a PLC 93, an RFID 90, a camera 96, a GPS signal receiver 89, a utility mapping program 97 and wireless communication via antenna 88 are illustrated as being used for documenting, controlling, displaying and storing data related to a utility servicing or repair operation or the like. A hand held PDA 95 is shown to give a person access to remotely control, gather data and monitor the servicing and repair event. The person wishing to use the PDA 95 is shown to first activate the PDA 95 by means of a personalized RFID tag 90. PDA 95 activation occurs when the person places his RFID tag 90 in communication with the RFID antenna 91. The PDA 95 will be activated provided that the persons RFID tag is programmed to activate the system. In this way the PDA 95 is protected from persons not authorized to use or operate the PDA 95. Use of the RFID tag 90 also documents personal data regarding who is using the system, what he used it for, for what period of time and what took place during his use of the PDA 95. The described RFID system is also illustrated as being mounted to the mobile platform 31 controller 34. The PDA 95 or the controller 34 are also illustrated to receive data from sensors 94 which measure physical quantities such as pressure, temperature, or flow of air, liquid, and solids, as well as measuring speed, counting rotations, measuring distance, counting time, measuring voltage, locate buried utilities and the like. The sensors 94 may send their data to a data logger 92 and or a PLC 93 which in turn may store the data, display it on a monitor screen for viewing by a person, use the data for process control, or generate archives of charts, graphs, and useful information formats for future evaluation such as storing the information onto a utility mapping program 97 and documenting. The utility mapping program 97 is illustrated as being displayed on the hand held devise 95. A GPS signal receiver 89 is illustrated as being used for receiving data from GPS satellites in order to document the latitude, longitude, elevation, time and or date that a utility service was performed. The GPS 89 data may be stored onto a data logger 92, a PLC 93 and a utility mapping program 97. Thus the mobile utility servicing machine as illustrated in FIGS. 5, 11 and 14 can access an in ground utility 15 with out mechanically damaging the utility 15, perform a service on a utility valve 98, and document who did the service, the physical location of the service, when the service started, what took place during the service event, when the service was completed, how the service event effected the overall utility system, update the utility data storage archives, and generate reports to those with a need to know. The system may also generate pictures and video of the service work. FIG. 5B illustrates another platform 31 mounted utility testing system quick coupled 77 to a skid steer 74, similar to FIG. 5. The fire hydrant tester illustrated in FIG. 5B could be included with the utility servicing systems illustrated in FIG. 5. FIG. 5B illustrates a mobile platform 31 quick coupled 77 to a skid steer 74 with an articulated boom means 36 mounted on said mobile platform 31. The remote controlled, powered, articulated boom means 36 is shown to have a linear actuator 41 illustrated a a powered means for lifting the telescoping boom arm. A torque wrench 32 is illustrated as being connected to and supported by the articulated boom means 36. The Torque wrench 32 is also illustrated a being used for opening or closing a fire hydrant valve 98. A water hose is illustrated for transporting water under pressure from the fire hydrant to a water diffuser 120 which is mounted on the mobile platform 31. Sensors 94 are illustrated to be measuring the performance of a fire hydrant and of the utility supply system. The data gathering system is shown to be hand held and capable of wireless transmission of the data. A water diffuser 120 is illustrated as receiving water 2 from the fire hydrant. The Diffuser 120 is also illustrated as discharging the water 2 onto the ground 35 with a minimum of pressure and a minimum of velocity. A De chlorinator 121 is illustrated as a means of removing chlorine from the water 2 before it is released to the ground 35.

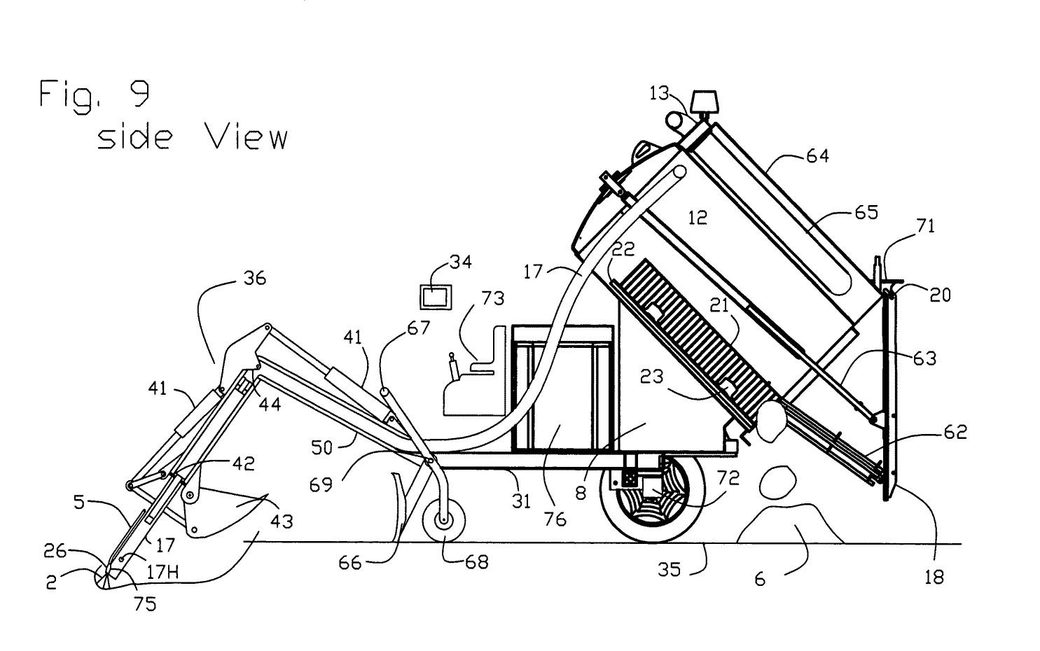

FIG. 9 illustrates an earth excavator which can alternate between the use of vacuum excavation & bucket 43 excavation. This is illustrated in this example by a vacuum container 12, with its components, mounted on a zero turn radius vehicle 31. An articulated powered vacuum conduit boom 36 is also mounted to the zero turn radius vehicle 31. The articulated powered vacuum conduit 17 boom 36 is constructed with sufficient strength to mount & operate an earth digging bucket 43 adjacent to the suction end of the vacuum conduit 17. The added means of a telescoping 42 section of vacuum conduit 17 extended to vacuum excavate or may be retracted to allow use of a bucket 43 for digging. The suction end of the telescoping 42 vacuum conduit 17 is shown to have a liquid spray nozzle 26 attached to the outer circumference of an indention 75 in the suction end of the vacuum conduit 17. The indention serves both to restrict the size of a solid entering vacuum conduit 17 to a size too small to get clogged in the conduit 17 & to serves as a location to mount the spray nozzle 26 at an orientation which will aim the s liquid 2 spray in a direction which will loosen & emulsify the earth 35 located at the suction end entrance of vacuum conduit 17. Controller 34 represents the sensors & monitors used to automate the sequencing of the articulation of the vacuum conduit boom 36 into location, the locating of utilities 15 by earth penetrating utility sensor 33, and the selection between & sequencing between earth digging bucket 43 & telescoping 42 vacuum conduit 17 & liquid spray nozzle 26. In this illustration a liquid spray nozzle 26 is shown to be used to loosen the dirt, but an air pressure nozzle may be substituted for the liquid spray nozzle 26 to loosen dirt thus making it vacuum able. A liquid 2 supply conduit 5 is shown to be mounted adjacent to the vacuum conduit 17 boom 36.

FIG. 8 shows a vacuum boring & mud recovery system preparing to clean a drainage pipe 38. A manhole cover 46 is being removed to gain access to the drainage pipe 38 by a manhole cover 46 removal attachment 47 mounted to the articulated powered vacuum conduit boom 36. A conduit 48 supplies power to the manhole cover removal attachment means 47. The manhole cover removal attachment means 47 may be an electro magnet, a suction cup or a mechanical attachment means. FIG. 8 represents a fifth embodiment of the vacuum container 2 showing the vacuum container 2 mounted on an inclined slope, supported by a liquid container 8 located beneath the incline of the vacuum container 12, and mounted on a generic mobile platform. The inclined angle is sufficient to allow the contents of the vacuum container to be removed by gravity when the door 18 is opened. A filter housing 64 having air filters disposed within it, is shown mounted adjacent to the vacuum container 12 in a configuration to allow simultaneous access to it & the debris tank 12 by a single door 12. A powered telescoping cylinder 63, chosen from a linear actuator or hydraulic, or air cylinder is shown mounted within the vacuum container 12 and to the access door 18. This telescoping cylinder 63 opens or closes the access door 18. A vibrating screen 21 is shown mounted to the access door 18 in this illustration. Mounting the vibrating screen 21 solids 6 liquids 2 separator to the access door 18 allows improved access for emptying & cleaning.

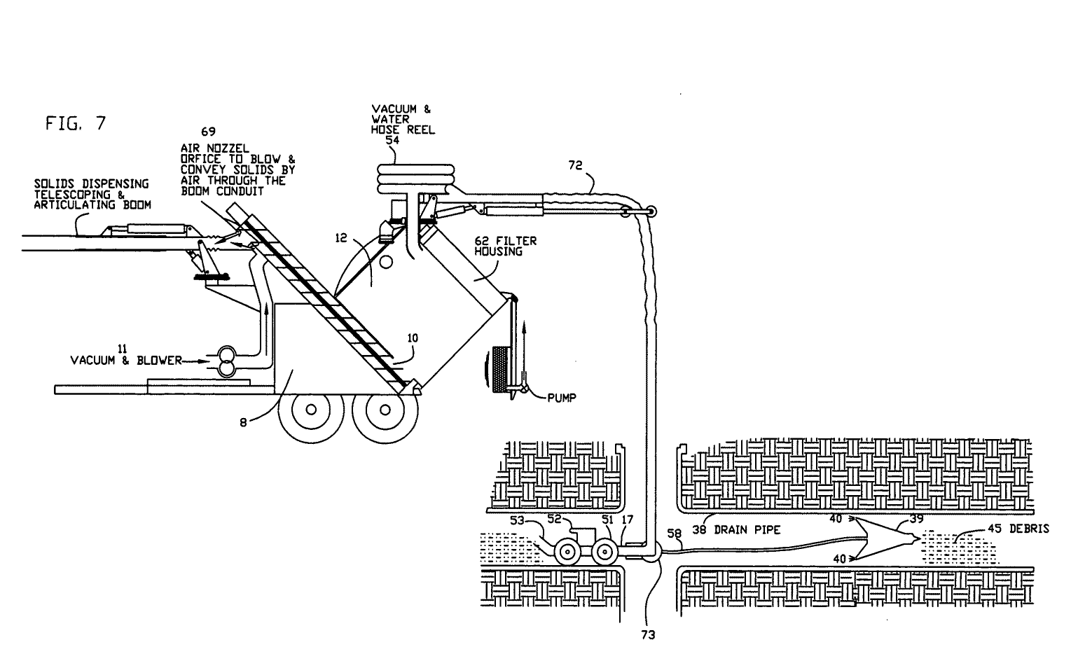

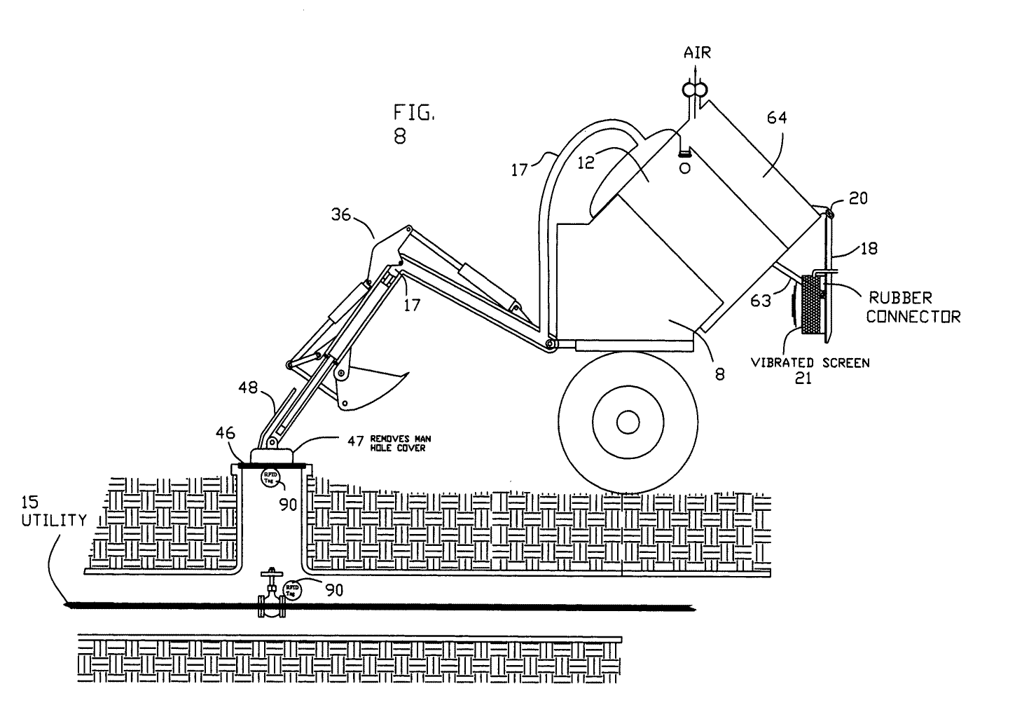

FIG. 7 shows an articulated powered jetter boom 60 having multiple boom sections 50 attached to a mobile platform. The boom 60 is shown loosening debris 45 from a drain pipe 38. Telescoping jetter conduit 61 provides extension of water jetter's reach. Rotary structural support means 44 provide swivel and rotating means.

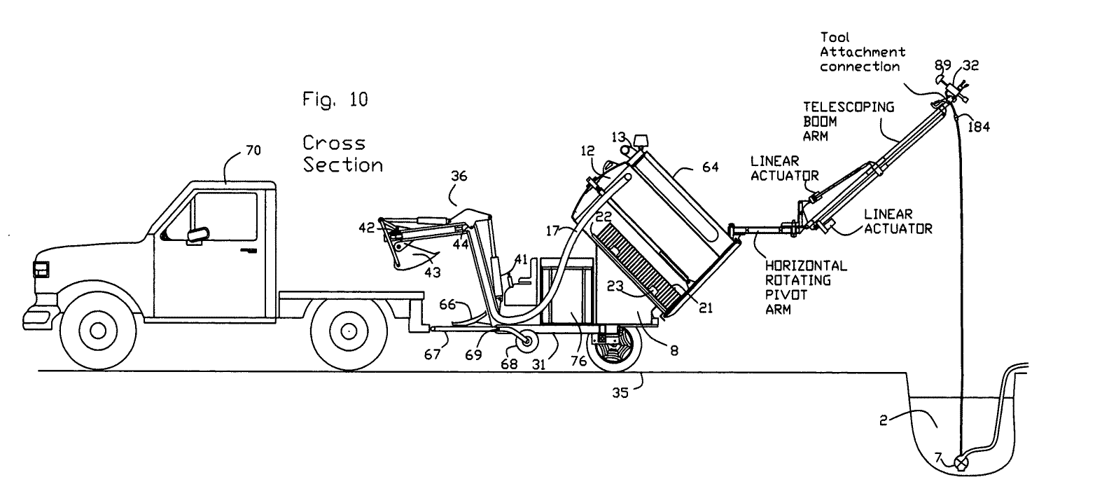

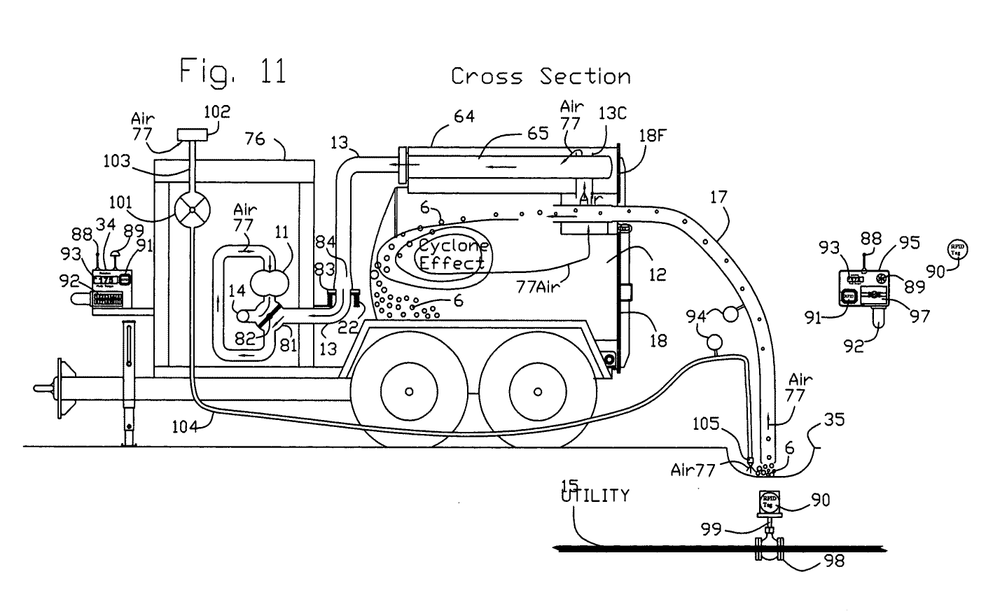

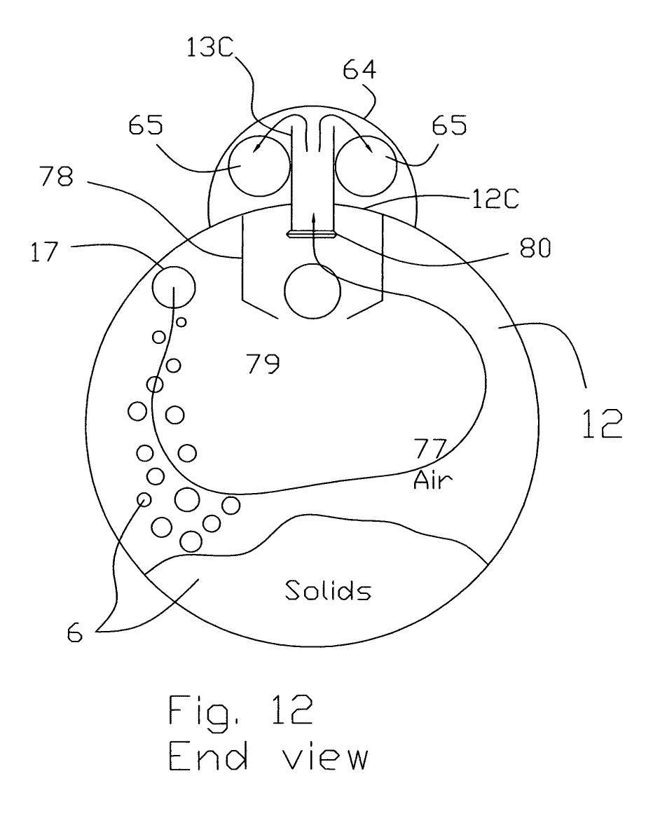

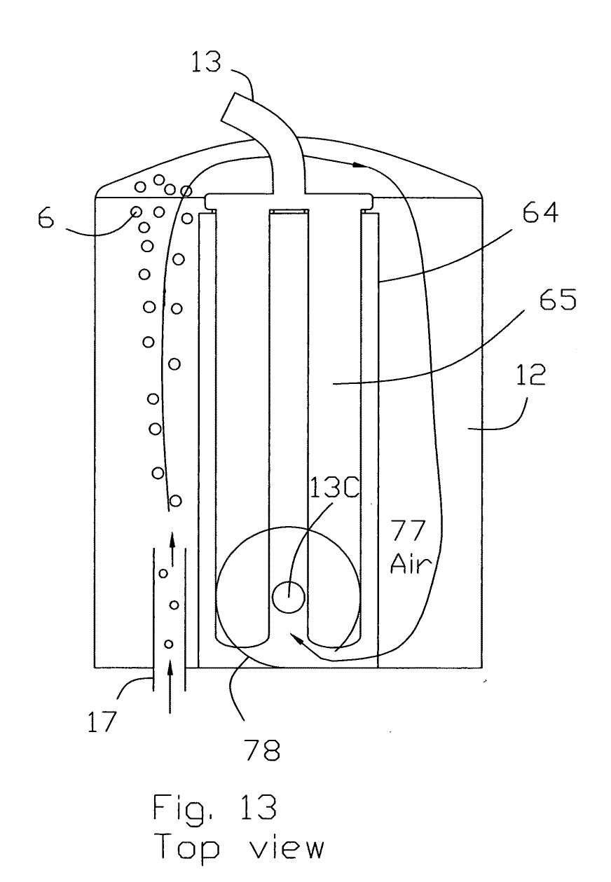

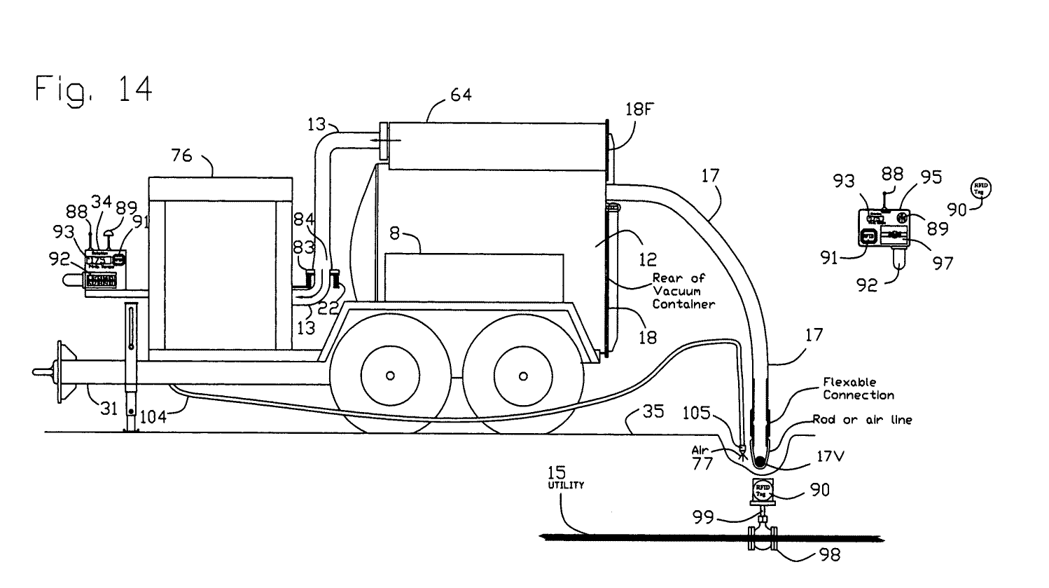

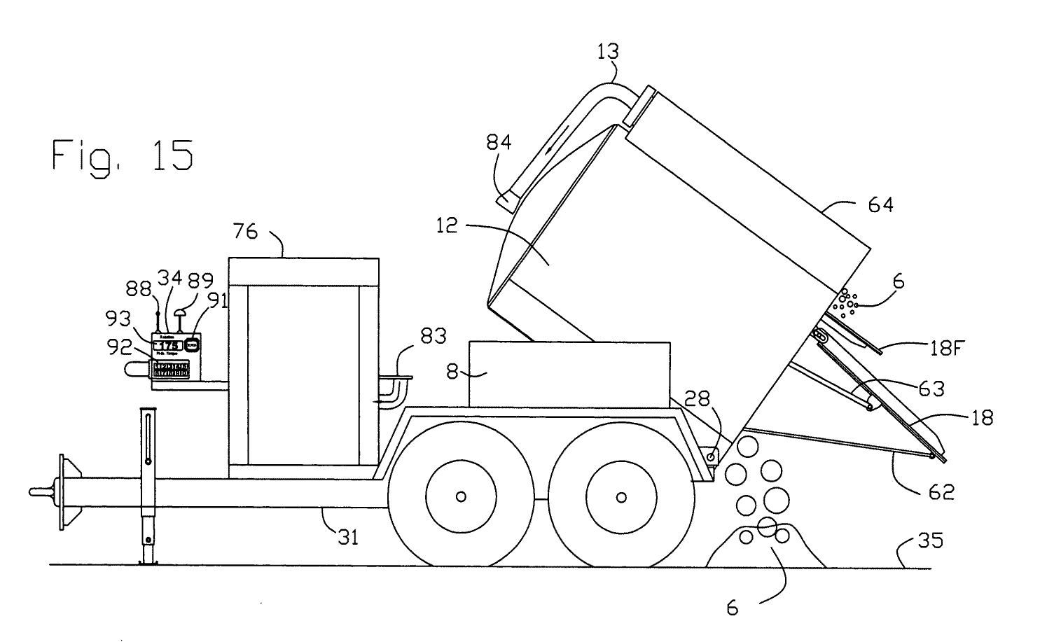

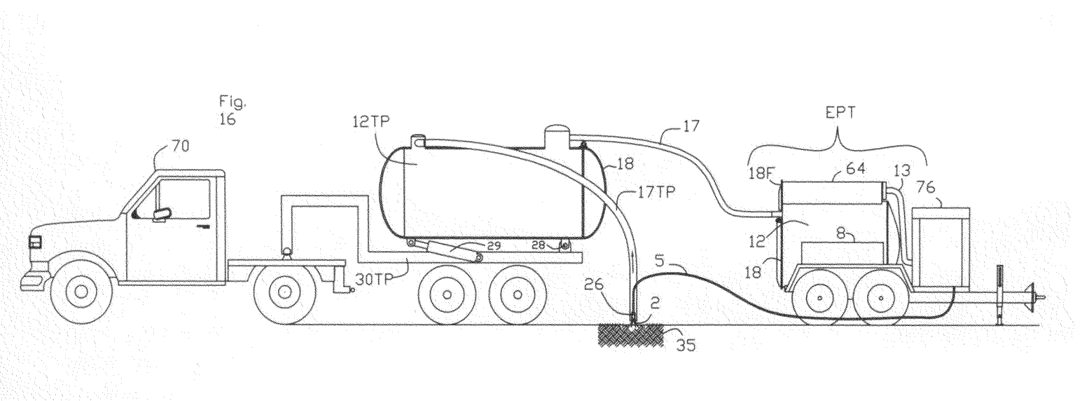

FIG. 9 Shows a cross sectional view of an vacuum boring & mood recovery unit digging a hole in the earth 35 using a vacuum container 12 mounted on a zero-turn radius vehicle 31 & having a solids 6 and liquid 2 separation means being a vibrating screen 21 and solids unloading drag bar 62 means. The Vacuum container 12 is shown connected to an vacuum conduit 17 which functions as part of the articulated boom 36 with has an earth digging bucket 43 attached in the retracted position. A telescoping section 42 of the vacuum conduit 17 is shown in the extended position vacuuming dirt 6 that has been emulsified by water 2 sprayed from a liquid spray nozzle 26 which is shown mounted in the outside circumference of an indention 75 in the suction end of the vacuum conduit 17. The indention reduces the size of solid 6 that can enter the vacuum conduit 17, thus reducing the frequency of solids 6 being clogged in the vacuum conduit 17. Near the suction end of the vacuum conduit 17 is illustrated a hole or orifice 17H in the side if the vacuum conduit 17. The size of said hole 17H and the number of said orifices 17H and the location of said orifice 17H is predetermined in order to allow a given quantity of air to enter the vacuum conduit for assisting in the air conveying of solids 6 or liquid 2 through said vacuum conduit 17. Vacuum excavation depends on the velocity of air flowing through the vacuum conduit 17 for conveying solids 6 or liquid 2. If the suction end of the vacuum conduit 17 becomes clogged then the air can no longer enter through the suction end of the vacuum conduit 17, thus stopping the air conveying of solids 6 or water 2, thus further clogging the vacuum conduit 17 along it's length. The addition of holes 17H provides an alternate place for air to enter said vacuum conduit 17, thus allowing the air conveying process to continue even if the suction end of said vacuum conduit 17 is clogged. Said hole 17H may also be equipped with a check valve means which will remain closed until the vacuum value within said vacuum conduit 17 reaches a predetermined vacuum. The suction end of the vacuum conduit 17 is also restricted 17R by rolling the sided of the suction inlet inward, which is commonly known as swedging the end of a pipe. The restriction 17R may also be accomplished by placing an indention in the suction end of the vacuum conduit 17. The restriction 17R also increases the air velocity at the suction end of conduit 17 thus improving the ability to vacuum up solids 6 or liquid 2. The earth excavator is shown to be secured in place during the excavation event by using the scrapper blade 66 as a jack to raise the front swivel wheels 68 off the ground 35. As shown in FIG. 10 the front swivel wheels 68 may be raised and the tow bar tongue 67 may be lowered thus readying the unit for towing as shown in FIG. 10. The excavator is shown in the excavating configuration. With the spreader blade 66 being used as a jack to sturdy the machine while digging. The debris access door 18 is shown opening by a powered telescoping cylinder 63 which in turn moves the pull bars 62 and dried dirt 6 out of the vacuum tank 12. In this illustration the water tank 8 and the power plant 76 which may include an engine, hydraulic motor, vacuum pump, air compressor, water pump, muffler or controls, are both positioned beneath the slope of the inclined slope vacuum container 12 thus creating an even more compact vacuum boring & mud recovery system with an even greater concentration of weight. The water tank 8 in FIGS. 8,9 & 10 are shown supporting the vacuum container 12. The operator controls the device from the operator seat 73. Control center 34 includes means to control solids 6 liquid 2 separation & recycling, functions of excavation, location & avoidance of utilities, mapping of work area, recording of performance.

FIG. 10 shows the device position behind a towing vehicle 70.

FIG. 11 shows a cross sectional side view of a trailer mounted vacuum excavator and surface cleaner with the filter housing 64 mounted above the vacuum container 12. An air conduit 13C allows air to flow from the vacuum container 12 to the filter housing 64 and then the air 77 flows through the air filter 65, the air conduit 13, through the conduit disconnect seal assembly 83 & 84. The air 77 is then shown passing through a 4 way diverter valve 81 which may be used to temporarily reverse the flow of air back through the air filter 65. The air flow reversing is important to assist in cleaning dirt from the filter 65 by blow dirt from the filter 65 to the cavity of the filter housing 64. This process is especially useful when vacuuming dusty dry solids such as during the process of using air under pressure for excavating dirt. Vacuum suction hose 17 is shown vacuuming solids 6 into the vacuum container 12 through it's rear wall. This side elevation shows the air path and depicts the cyclone effect created by locating both the conduit 13C and the vacuum hose 17 discharge adjacent to each other as well as being adjacent to the vacuum tank rear access door 12. The air 77 is shown to slow in velocity, change directions and precipitate the solids it has been carrying adjacent to the bottom front of the vacuum container. The air filter housing 64 and the vacuum container 12 are also shown to be separated by a common dividing wall.

An air compressor 101 is shown to receive air 77 through an air filter 102. The air 77 flows through conduit 103, then through air compressor 101 then through conduit 104 then through air nozzle 105 just before air 77 impinges the earthen material 35 thus making the earthen solids 6 more vacuum able.

FIG. 12 shows a cross sectional end view of a trailer vacuum excavator like is shown in FIG. 14. This view allows a better visualization of the relation ship between the air conduit 13C, and the high level vacuum shut off ball 79. The baffle 78, the rear vacuum hose inlet 17, an end view of the air filters 65 orientation relation ship is also shown. The air flow 77 is also shown dropping solids 6.

FIG. 13 shows a cross sectional top view of a trailer vacuum excavator like is shown in FIG. 14. This view allows a better visualization of the relation ship between the air conduit 13C, and the rear vacuum hose inlet 17, and the air filters 65. The air flow 77 is also shown dropping solids 6.

FIG. 14 shows a trailer 31 vacuum excavator side view with the vacuum tank laying horizontal during the process of filling it with solids or liquid. The air filter housing 64 is shown mounted horizontally above the vacuum container 12. The filter housing door 18F and the vacuum container rear access door 18 are both shown in the closed position during the vacuum filling of the vacuum container 12. Vacuum conduit 17 is shown to be vacuum air conveying solids 6 from the ground 35 into the vacuum container 12. Air 77 under pressure is shown to be discharged through air nozzle 105 for the purpose of loosening the earthen material thus making it vacuum able. A vibrator 17V is also being used to loosen the earthen material in order to make it vacuum able. The vibrator 17V is position adjacent to the suction end of the vacuum conduit 17 and may be attached to the suction end of the vacuum conduit via a flexible connection. The vibrator 17V may be powered by air, electric, hydraulic or the like. A rod or blade or conduit may be attached to the vibrator 17V for the purpose of attachment and for adding to the earth loosening process. The pressurized air conduit may be a part of the vibrator attachment means and may have orifices tragically placed in said pressurized air conduit for the purpose of loosening earthen material adjacent to the suction end of said suction end of said vacuum conduit 17. Water 2 may be introduced into said pressurized air at a regulated rate so as to add mass to the air 77 excavation process. Greater mass increases the rate of making earthen material vacuum able. The water 2 volume may also be regulated proportionate to the amount of dust versus mud is desired. Water storage container 8 is shown as a saddle tank mounted adjacent to the trailer 31 finders & wheels. The suction end of the vacuum conduit 17 is being used for providing access to a buried valve 98 which has an RFID tag 90 positioned adjacent to a valve stem 99 adapter. The RFID tag 90 has been activated and used to locate the buried valve 98. The RFID tag 90 may have data stored which saves and documents the events of this service activity. The RFID tag 90 in this illustration is imbedded within a valve stem 99 adapter so that the RFID tag 90 remains with the valve 98 for the purpose of assisting in the process of locating and identifying information relative to the maintenance and performance of said valve 98. An RFID antenna 91, sensors 94 and a data logger 92 may be used in conjunction with the RFID tag 90.

FIG. 15 shows a trailer 31 vacuum excavator side view with the vacuum container 12 temporally raised to an inclined position for the purpose of unloading solids 6 from the vacuum container 12. The vacuum container 12 read door 18 is shown in the open position with solids 6 flowing from the vacuum container 12. The filter housing 64 rear access door 18F is shown emptying solids 6. The rear access door 18F gives access to empty solids from the filter housing 64 by gravity as well as giving the operator a user friendly access to the air filters 65. The open rear access door 18F gives the operator easy access to insert a pressurized water nozzle within the filter housing 64 in order to wash clean both the air filters 65 and the filter housing 64. The wash water and dirt flow freely by gravity from the filter housing 64. The vacuum container can also be washed clean by the operator using a pressurized water nozzle & gravity. Permanent wash nozzles way be mounted and piped into the filter housing 64 or vacuum container 12. Remote controls can be used to operate the water nozzles.

FIG. 16 shows a trailer mounted vacuum excavation machine EPI per the present invention showing its vacuum conduit 17 connecting a vacuum container 12TP. The vacuum tank 12TP is shown mounted on a trailer 30TP being pulled by a truck 70. Vacuum container 12TP is shown getting it's vacuum source through conduit 17. Conduit 17TP is shown vacuuming earthen material 35 into the vacuum container 12TP. Water under pressure 2 is shown passing through water conduit 5 & through water spray nozzle 26 in order to impinge the earthen material 35 and make it vacuum able. Vacuum excavation machine EPI is shown supplying the power, vacuum source, and pressurized water supply for the excavation. The larger vacuum container 12TP is shown as a storage container for vacuumed solids & liquid. When it is filled, it will be hauled off to an unloading location by truck 70. The EPI vacuum excavator will remain in place ready to fill another 12TP vacuum container. Thus this arrangement functions like a track loader filling a dump trucks with dirt.

The preceding description has been presented to illustrate and describe the invention. It is not intended to be exhaustive or to limit the invention to any precise form disclosed. Many modifications and variations are possible in light of the above teaching.

The sample embodiments were chosen and described in order to explain the principles of the invention and its practical application. The preceding description is intended to enable others skilled in the art to best utilize the invention in various embodiments and with various modifications as are suited to the particular use contemplated. The invention includes a variety of tools and processes. Further patent divisional and continuations of this patent application will be filed for the purpose of claiming each of the novel tools and process which have been taught and illustrated in this patent application. It is intended that this invention be defined by the following claims.

1. An apparatus for separating solids or liquid from air within a vacuum container, which is used for vacuum excavation of earthen materials, comprising:
(a) a mobile platform means;
(b) a vacuum container, and said vacuum container having a length and width, and further comprising a vacuum producing means for creating a vacuum environment within said vacuum container; wherein said vacuum container is adjacently mounted on said mobile platform;
(c) an access door means for emptying solids or liquid from said vacuum container wherein said access door is adjacently mounted on said vacuum container;
(d) a vacuum conduit means for vacuuming solids or liquid into said vacuum container, wherein said vacuum conduit has a first end and a second end; and said second end of said vacuum conduit means is adjacently connected in communication with said vacuum container, and said first end of said conduit means is the suction inlet end of said conduit means;
(e) an air filter housing means for filtering solids from air and said filter housing having a length and width, and said length of said filter housing being adjacently mounted to said length of said vacuum container, and further comprising said vacuum container and said filter housing sharing a common divider wall and said filter housing further comprising a conduit means for flowing air from said vacuum container to said filter housing and said vacuum container adding structural support to said filter housing.

2. An Apparatus for servicing an in ground utility valve comprising:
(a) a mobile platform means;
(b) a coupling means for attaching said platform to a skid steer;
(c) a boom arm means for supporting a powered valve actuator, and said boom arm having a first end and a second end, wherein said first end of said boom arm is pivot ably mounted on said mobile platform; and said second end of said boom arm further comprises an attachment means for attaching a powered valve actuator;
(d) a powered valve actuator wherein said powered valve actuator means is mounted adjacent to said second end of said boom arm means.

3. The apparatus of claim 1, further comprising:
(e) a sensor means and a data logger means for gathering and storing data relative to a service event.

4. The apparatus of claim 2, further comprising: a water diffuser means for receiving water from a fire hydrant wherein said water diffuser is adjacently positioned on said mobile platform; and further comprising a water hose for coupling said fire hydrant to said water diffuser.

5. An Apparatus for servicing or cleaning a utility sewer or drainage pipe comprising:
(a) a mobile platform means;
(b) a water jettering system consisting of at least a water pump, a water hose, and a hose reel, wherein said water jettering system is adjacently mounted on said mobile platform;
(c) a boom arm means for supporting said hose reel, and said boom arm having a first end and a second end, wherein said first end of said boom arm is rotate ably mounted on said mobile platform, and said hose reel means is mounted adjacent to said second end of said boom arm means;

6. The apparatus of claim 5, further comprising:
(a) a vacuum container, and said vacuum container having a length and width, and having a vacuum producing means for creating a vacuum environment within said vacuum container; wherein said vacuum container is adjacently mounted on said mobile platform;
(b) an access door means for emptying solids or liquid from said vacuum container wherein said access door is adjacently mounted on said vacuum container;
(c) a vacuum conduit means for vacuuming solids or liquid into said vacuum container, wherein said vacuum conduit has a first end and a second end; and said second end of said vacuum conduit means is adjacently connected in communication with said vacuum container, and said first end of said vacuum conduit means is the suction inlet end of said conduit means.

7. The apparatus of claim 5, wherein said rotate able means is selected from the group consisting of a shaft with a bearing plate, a hollow shaft with bearing and a seal, and a slewing ring gear drive such as a Model S-7 hourglass worm slew drive made by Kinematics Mfg. Inc.,

8. The apparatus of claim 6, further comprising a guider support means for positioning said vacuum conduit wherein said guider support is pivot ably mounted adjacent to said hose reel.

9. The apparatus of claim 2 or 5 further comprising a sensor means and a data logger means for gathering, storing and documenting information relative to a service event.

10. The apparatus of claim 2 or 5 further comprising a GPS signal receiver means for determining a position of a service event.

11. The apparatus of claim 2 or 5 further comprising an RFID means for receiving data relative to a service event.

12. The apparatus of claim 6 further comprising a vibrator means for improving the vacuum able of earthen material, wherein said vibrator means is adjacently mounted in communication with the first end of said vacuum conduit.

13. (canceled)

14. The apparatus of claim 1, 2 or 5 further comprising a data collection means for documenting data relative to a service event wherein said data collection means is selected from the group consisting of a sensor, a data logger, a PLC, an RFID tag, an RFID antenna, a wireless transmitter/receiver, a computer, a hand held electronic device, a camera, a GIS map, a GPS, and a PDA wherein said data documentation means is positioned adjacent to said mobile platform.

15. The apparatus of claim 6 further comprising an orifice means for allowing air to enter the side of said vacuum conduit, wherein said orifice means is positioned adjacent to the suction end of said vacuum conduit; and further comprising a restriction means for limiting the size of solids which can enter said suction end of said vacuum conduit, wherein said restriction means is positioned adjacent to said suction end of said vacuum conduit.

16. The apparatus of claim 6, further comprising; a vacuum hose reel means for storing said vacuum conduit wherein said vacuum conduit reel is rotate ably mounted adjacent to said vacuum container, and further comprising a rotate able means for mounting said vacuum conduit reel and said rotate able means is selected from the group consisting of a shaft with a bearing plate, a hollow shaft with bearing and a seal, and a slewing ring gear drive such as a Model S-7 hourglass worm slew drive made by Kinematics Mfg. Inc.
